(19) United States
(12) Patent Application Publication
(10) Pub. No.: US 2014/0222700 A1
(43) Pub. Date: Aug. 7, 2014

(54) PREDICTIVE PAIRING AND/OR MATCHING SYSTEMS, APPARATUS, AND METHODS

(71) Applicants: Jude Galligan, Austin, TX (US); Chris Chilek, Austin, TX (US); John Cunningham, Austin, TX (US)

(72) Inventors: Jude Galligan, Austin, TX (US); Chris Chilek, Austin, TX (US); John Cunningham, Austin, TX (US)

(73) Assignee: Home Zoo, LLC, Austin, TX (US)

(21) Appl. No.: 13/759,231

(22) Filed: Feb. 5, 2013

(51) Int. Cl. G06Q 30/02; G06Q 50/16; G06Q 50/00

(52) U.S. Cl. CPC G06Q 30/02; G06Q 50/01; G06Q 50/16
USPC 705/319

(57) ABSTRACT

Systems, methods, and apparatus for psychometrically pairing real estate agents with potential real estate clients. Some methods include retrieving social data for social network members. Such methods also include comparing the social data to a profile of the agent to psychometrically pair the members as potential clients for the agent. Some methods include outputting an indication (for instance likelihoods) of psychometric pairings of clients and the agent. Images of property can be distributed to the members and their image rankings can be received. The image rankings can be used to psychometrically match the clients with the property. The matchings and pairings can use the rankings and real estate criteria received from the members. The social data can be used to match the clients with property. Pairings of the clients and the agent can use the criteria. Some social data can be for a connection involving the client.

### BACKGROUND

Professional service providers seeking clients face a number of difficulties in finding good matches. From among many types of professional service provides take real estate agents for instance. Each transaction which they shepherd through a deal represents an enormous undertaking fraught with risk that is difficult to predict. One of those risks relates to the quality of the client(s) involved and whether they would be a good “fit” with the agent. As almost any experienced professional will tell you, some clients fit quite well while working with other clients can be nerve-wracking. Prior to the disclosure herein, no practicable way existed to predict which clients might work out and which ones might not.

Moreover, finding clients has been a task that required relatively large investments in marketing, advertising, networking, etc. In the alternative, or in addition, luck or serendipity also played a relatively large role in whether an agent found good clients. Then, once found, the task of building relationships and keeping the good clients (as judged subjectively) has represented another challenge. This situation is so particularly when an otherwise good client does not fit well with the agent on a personal basis. Despite professional success in delivering a good monetary deal to the client, such personal bad fits might still result in the loss of the client or at least the loss of repeat, future business therefrom. Again, going into the deal, the professional services provider has had no way to predict whether a fit will occur.

Historically, real estate agents have found clients through advertising and referrals. These efforts often require relatively great expense and significant investments of time on the agent's part. Often, contacts of the agent who wish to enter the real estate market might have forgotten (or not appreciated) that they know that real estate agent. In other cases they would, for some reason unknown to the agent, fail to contact the agent. Thus, the connection between the potential client and agent has been both difficult to create and also to maintain. Significant expenses were therefore often incurred for advertising by the agent to frequently remind their potential clients of their availability. Nonetheless, some of the agent's contacts still might not see or appreciate the agent's advertisements, reminders, etc. Thus, not even well planned marketing campaigns would always result in successfully landing a particular contact(s) as a client.

As a result, those agent-client relationships that did develop through such techniques usually arose through a combination of luck, fortunate timing, and other factors beyond the agent's control. And, of course, keeping clients and potential clients up to date regarding current listings that match their objective criteria (cost, square footage, location, etc.) has been difficult too. When the client's subjective tastes related to real property (for instance, some clients prefer “cute” properties while others prefer utilitarian or spartan properties) are factored in, identifying properties that “fit” the client has been even more difficult. Indeed, sometimes a client's subjective considerations have been known to overwhelm their more objective criteria thereby surprising the agent and setting back the deal making process. Such considerations also come into play during the rendering of many professional services.

### SUMMARY

The following presents a simplified summary in order to provide a basic understanding of some aspects of the disclosed subject matter. This summary is not an extensive overview of the disclosed subject matter, and is not intended to identify key/critical elements or to delineate the scope of such subject matter. A purpose of the summary is to present some concepts in a simplified form as a prelude to the more detailed disclosure that is presented herein. The current disclosure provides systems, apparatus, methods, etc. for predictively pairing professional service providers with potential clients and more particularly predictively and/or persistently pairing real estate agents with real estate clients using social network data regarding the agent, the clients, and perhaps others.

Embodiments disclosed herein provide systems, apparatus, methods, etc. for identifying potential clients for professional service providers. More specifically, embodiments allow professional service providers to identify clients via online, computerized, social networks. In some embodiments, the professional service providers are real estate agents. Embodiments also allow these professional service providers to evaluate the potential clients and, once satisfied, offer some, all, or none of the potential clients an opportunity to establish a long-term relationship(s) with the professional service provider and to make that status available to various social networks. Moreover, if desired, the professional service provider can be persistently identified across various social networks as that client's preferred provider for the corresponding type of professional services.

From the client perspective, embodiments allow potential clients to identify service providers of a desired type. Moreover, these potential clients can also select, from among their connections, a professional with whom they wish to (persistently) pair. As a result, long-term relationships between these clients and the professional can be facilitated by embodiments.

Some embodiments provide methods which include various operations such as accessing social network data for each of a plurality of social network members using a processor. The methods of the current embodiment also include comparing the social network data for each of the social network members to a profile of a real estate agent to psychometrically pair the social network members as potential real estate clients for the real estate agent using the social network data and the processor. Additionally, methods include outputting an indication of at least one psychometric pairing of a potential real estate client with the real estate agent via an interface in communication with the processor.

Methods of some embodiments also comprise distributing images related to professional services (for instance real estate related services) to various users and accepting rankings of the images from the users. If desired, methods also comprise using the image rankings in a psychometric matching of potential professional services clients with the professional services related to the images. Further, the psychometric matchings and pairings can use the image rankings and certain criteria received via the interface. Further, methods of some embodiments use the social network data in psychometrically matching potential clients with various professionally rendered services. Moreover, the psychometric pairing of potential real estate clients and the prospective service providers can further comprise using criteria regarding the professional service providers received from the potential client via the interface. In some situations the social network data for one of the potential clients further comprises social network data for a connection of the potential client. In the alternative, or in addition, the indication of psychometric parings can be the likelihoods of those psychometric pairings. Of course, in some scenarios, there might only be one psychometric pairing and its likelihood could be high.

Various embodiments provide apparatus for psychometrically pairing potential real estate clients and real estate agents. These apparatus include an interface, a memory, and a processor in communication with the interface and the memory. The memory stores processor executable instructions which when executed by the processor cause the processor to perform a method further comprising accessing social network data for each of a plurality of social network members. Methods of the current embodiment also comprise comparing the social network data for each of the social network members to a profile of a real estate agent to psychometrically pair the social network members as potential real estate clients for the real estate agent using the social network data. Such methods also comprise outputting an indication of the psychometric pairings of the potential clients with the real estate agent profile via the interface.

With apparatus of some embodiments the methods performed by the processor also comprise distributing images of real properties to the social network members and accepting rankings of the images from the social network members. If desired, methods of the current embodiment also comprise using the image rankings in psychometric matchings of the potential real estate clients with the properties. Further, the psychometric matchings and pairings can use the image rankings and real estate criteria received via the interface. Further, methods of some embodiments use the social network data in a psychometric matching of potential real estate clients with real properties. The psychometric pairing of potential real estate clients and the real estate agent can further comprise using real estate criteria received from the potential real estate client via the interface.

In apparatus of some embodiments the social network data for one of the potential real estate clients further comprises social network data for a connection of the potential real estate client in the social network. In the alternative, or in addition, the indication of psychometric parings can be the likelihoods of those psychometric pairings. Of course, in some scenarios, there might only be one psychometric pairing and its likelihood could be high.

To the accomplishment of the foregoing and related ends, certain illustrative aspects are described herein in connection with the annexed figures. These aspects are indicative of various non-limiting ways in which the disclosed subject matter may be practiced, all of which are intended to be within the scope of the disclosed subject matter. Other advantages and novel features will become apparent from the following detailed disclosure when considered in conjunction with the figures and are also within the scope of the disclosure.

### BRIEF DESCRIPTION OF THE FIGURES

The detailed description is described with reference to the accompanying figures. In the figures, the left-most digit(s) of a reference number usually identifies the figure in which the reference number first appears. The use of the same reference numbers in different figures indicates similar or identical items.

FIG. 1 illustrates a system for predictively pairing professional service providers and clients.

FIG. 2 illustrates a system for predictively pairing real estate agents and real estate clients.

FIG. 3 illustrates a flowchart of a method for identifying potential real estate clients.

FIG. 4 illustrates a flowchart of a method for identifying potential professional services clients.

FIG. 5 illustrates a flowchart of another method for identifying potential professional services clients.

### DETAILED DESCRIPTION

This document discloses systems, apparatus, methods, etc. for predictively pairing professional service providers with potential clients and more particularly predictively and/or persistently pairing real estate agents with real estate clients using social network data regarding the clients and others.

Professional service providers each provide a unique “product” in the market place. It is not just that the services that they provide are often difficult to deliver, but each individual provider is a unique source of those services. Indeed, the law recognizes that personal service contracts rely heavily on the talents, skills, experience, insights, personal history, relationships, etc. that the professional brings to the contract. Indeed, in many situations, the professionals delivering such services are so unique that courts will not allow these professionals to replace themselves with other professionals in performing their services even under adverse circumstances. Indeed, damages in such personal service contracts often turn on the difficulty and expense in finding a replacement: not on the actual damages suffered or likely to be suffered by the client.

Thus, computerized systems for identifying professional service providers have largely failed to satisfy the market. Indeed, many such computer-based systems simply list the professionals and their purported qualifications. Some of these systems provide geographic or zip code based listings of professional service providers to allow some crudely targeted advertising for these providers. Still other such systems have attempted to capture the “quality” of the individual professionals by providing reviews from their previous clients. But clients all have subjective tastes and each contract or performance reviewed was likely to have been unique. Thus, even these review-based computerized systems provide little in the way of predicting how a particular professional and a particular client will interact or “fit.” And while some computerized systems exist for psychometrically matching “goods” with consumers, it is believed that none of these heretofore-available systems have addressed the nuances and vagaries peculiar to pairing professional or personal service providers (and/or their services) and their clients.

Moreover, contractual subject matter dominated by subjective and/or highly personal tastes, emotional motivations, etc. render heretofore-available computerized, systems even less effective for professional services. The real estate agent-client relationship illustrates the more general situation with regard to professional service providers in many ways. While real estate property can be bought and sold just as goods can be bought and sold from a simplistic viewpoint: much more goes into a real estate transaction than transactions involving mere ordinary goods. For one thing, many real estate clients intend to live in or on their purchase (respectively, their home or lot). Not surprisingly, strong emotions can enter into their decision-making. Having an agent that they are comfortable with and trust therefore often plays a key role in determining their satisfaction with the purchase of their new “home.”

If a first transaction with a particular real estate agent goes “bad” (viewed subjectively by the client of course) that client is unlikely to return to that agent for future transactions. Similarly, a seller under pressure to unload a piece of real property (particularly in a down market) who suffers through a deal with an ill-fitted agent will likely find another agent for their next transaction. In both cases, all or most of the work and expense that the agents have invested in those relationships goes to waste. The agents must then go back to work locating and/or identifying potential clients, developing those relationships, and waiting to see if a fit with the new client(s) develops. Since no previous system, method, etc. allows these professional service providers (the real estate agents) to predict with any degree of certainty whether a fit will develop, these agents can only test their guesswork by trial-by-fire during deals which often involve high-stakes (both monetary and subjective) for the clients. Embodiments of the current disclosure provide systems, apparatus, methods, etc. for predictively pairing real estate agents and clients. Moreover, embodiments can also provide for predictively pairing other professionals (e.g., lawyers, artists, doctors, actors, writers, stock brokers, lenders, etc.) with potential clients. Thus, at this juncture, it might now be useful to consider the figures.

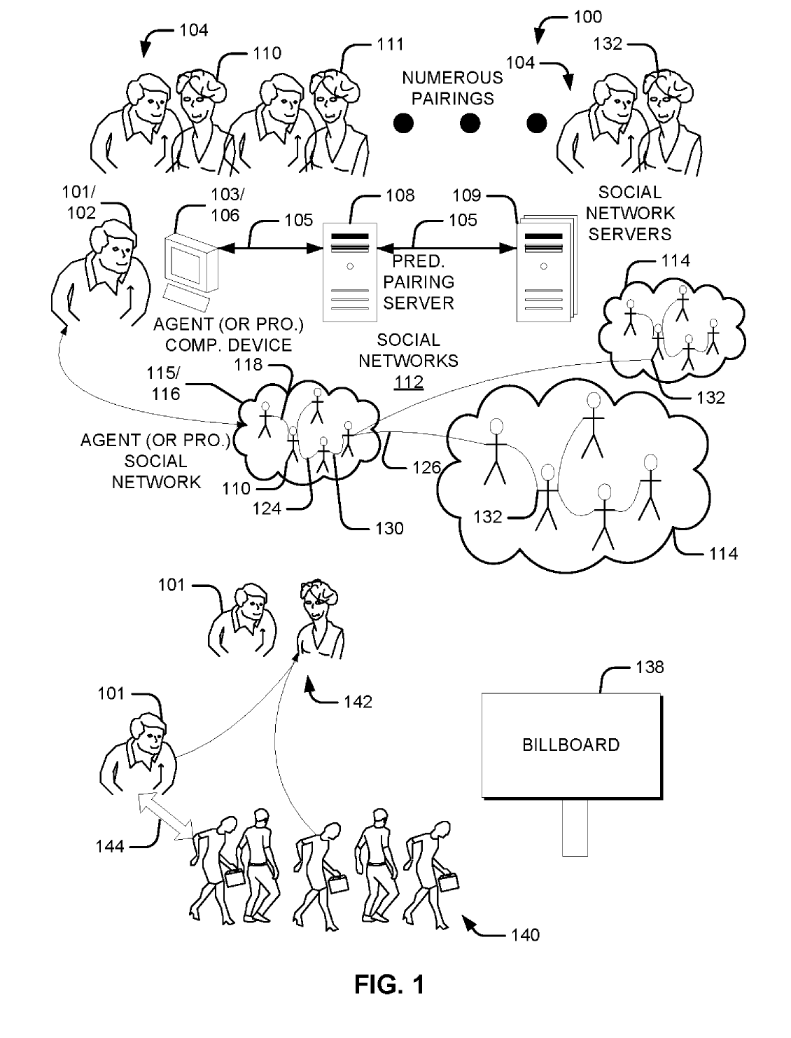

First, FIG. 1 illustrates a system for predictively pairing professional service providers and clients. More specifically, FIG. 1 illustrates a system 100 including professional service provider 101, real estate agent 102, provider computing device 103, pairings 104, communication network 105, agent computing device 106, predictive pairing server 108, social network servers 109, close contacts 110, secondary contacts 111, social networks 112, personal networks 114, provider network 115, agent network 116, primary connection 118, secondary connection 124, tertiary connections 126, tertiary contact 130, distant contact 132, marketing efforts 138, population 140, and fortuitous relationship 142. System 100 of the current embodiment allows provider 101 to identify potential clients with whom they will likely form successful long-term relationships as illustrated by provider-client pairings 104. Thus, system 100 can be said to predictively identify which contacts (whether primary, secondary, tertiary, or distant) might be good fits as clients for provider 101. More specifically, system 100 uses psychometric pairing to do so in many embodiments. Indeed, system 100 accounts for the nuances and vagaries involved in personal and/or professional service contracts as well as those subjective and/or emotional considerations often involved in professional services in predictively pairing providers 101 and potential clients.

Generally, a provider 101 can log onto the predictive pairing server 108 via provider computing device 103 and communication network 105. Once logged on, in systems 100 of the current embodiment, the provider 101 can request that predictive pairing server 108 query their provider network 115 (and other personal networks 114 connected thereto through the social network(s) 112) for potential clients. Predictive pairing server 108 responds by crawling or otherwise examining one or more of the provider's networks 115 via social network servers 109 for potentially good clients or “fits” for providers 101. It does so by gathering social network data from the provider's network 115 (and other personal networks 114 connected thereto) and performing a psychometric pairing against a profile of the provider stored or maintained by the predictive pairing server 108. At some point, the predictive pairing server 108 determines that it has gathered enough social network data regarding various contacts (close contacts 110, secondary contacts 128, tertiary contacts 130, distant contacts 132, etc.) in or connected to provider network 115 through the social networks 112. It can then output a listing of the provider-client pairings 104 that it determines might produce one or more good clients for provider 101.

With continuing reference to FIG. 1, predictive pairing server 108 can be any type or combination of available computing devices (such as a cloud-based implementation) or even those to be developed in the future capable of performing the methods disclosed herein. Indeed, predictive pairing server 108 can be a webhosting server, another type of server, a personal computer (of many possible types such as a desktop computer, a laptop computer, etc.), an artificial intelligence device (for instance, a neural network), etc. The predictive pairing server 108 communicates via the communications network 105 with other devices such as the provider computing device 103 and various social network servers 109. Moreover, the predictive pairing server 108 gathers social network data from the social network servers 109, runs a psychometric pairing engine against that data, and sends to the provider computing device 103 the provider-client pairings 104 or indications thereof.

The social network servers 109 are typically webhosting servers and/or third party computing devices which host various social networks 112 or the applications, programs, algorithms, personal pages, databases, etc. which constitute those social networks. Of course, the social network servers 109 need not be webhosting servers. Furthermore, system 100 might include one or more such devices and/or the social networks 112 could be distributed or Torrent-like systems. The social networks 112 can include Facebook®, LinkedIn®, Google +™, Match.com™, Twitter®, etc. Many of these social networks 112 (and others yet to be developed) allow their members to define or build personal networks 114 therein with other members of the social network. These members are said to be connected to each other although the labels used to describe a contact or connection in a given social network might vary. For instance, Facebook® refers to some contacts as “friends.” Moreover, most social networks 112 maintain a variety of data regarding each of its members including to whom they are connected, personal information or profile information, their activities, their likes, their dislikes, past work information, whether other members (dis)like them, whether other members have “unfriended” them, their fan pages, etc. Of course, since each member of a social network 112 can connect to other members, these social networks 112 often involve secondary, tertiary, and even more distant connections. Thus, each social network 112 can include a variety of social network data pertaining to each of their members and the way these members interact with each other

Further still, in many cases, one person will create personal networks 114 within one or more social networks 112 and sometimes their social network data in one social network 112 will reference, or point to, their membership in another social network 112. Thus, predictive pairing server 108 can be configured to follow such references and potentially obtain a wealth of data on various members of interest regarding their subjective tastes. More specifically still, predictive pairing server 108 can be configured to search for social network data for such members that shed light on their tastes related to services performed by professional service providers 101 (such as real estate agents 102). Using social network data gathered from one member's contacts related to the professional services of interest can allow the predictive pairing server 108 to infer what that member's subjective considerations might be in finding a provider 101 that they would enjoy working with (and with which they might find success as they judge it subjectively).

With continuing reference to FIG. 1, provider computing device 103 can be any sort of computing device capable of participating in system 100 whether of a type now available or yet to be developed. Such provider computing devices 105 include but are not limited to desktop computers, laptop computers, tablet computers, smart phones, personal digital assistants, etc. Whatever their form, they allow professional service providers 101 to access the predictive pairing server 108 over the communications network 105 and request and obtain provider-client pairings 104 and (as is disclosed further herein) potential matchings of services (or products thereof) and clients. In addition, if desired, the provider computing devices 103 allow providers 101 access to the social networks 112 and/or the social network servers 112 via communications network 105 or by other techniques. Thus, provider computing devices 103 can facilitate provider 101 participation in social networks 112 as a member of one or more of the same.

Provider-client pairings 104 typically include one or more contacts (in the social networks 112 or elsewhere) of the provider as the client or potential client. Of course, a client is an individual or other entity that has formed a relationship with the professional service provider 101 whether long-term or initial. The client might be a person, a married couple, a group of individuals, an association, company, corporation, or other entity. Furthermore, in the current embodiment, these provider-client pairings 104 have often been found by the predictive pairing server 108 although some pairings can arise from other sources. For instance, some provider-client pairings might pre-date the provider's 101 use of the predictive pairing server 108 and some might arise spontaneously from the provider's other activities.

With further reference to FIG. 1, each personal network 114 includes a particular member (a base member) who has built or defined that personal network 114. It therefore includes primary connections 118 secondary connections 124, tertiary connections 126, etc. of its base member. Thus, a personal network 114 will include close contacts 110, secondary contacts 128, tertiary contacts 130, and even distant contacts 132 of the base member. As FIG. 1 illustrates, these personal networks 114 can be viewed as stand-alone networks. But, they can also overlap and/or share members as defined by the various connections there between. As a result, it is possible to navigate through a social network 112 between various personal networks 114 by following these connections. And, as noted elsewhere herein, it is possible to follow references from one social network to another for the base member and/or for their contacts.

Furthermore, each member of these networks (in their real-life dealings) is likely to associate with other people who share similar tastes, experiences, associations, memberships, likes, dislikes, etc. Many social networks 112 have been configured to reflect and document such subjective considerations of their members' lives. The activity of the members on these social networks 112 (such as frequency and length of contact with other members) also provides information related to their subjective considerations. Strong connections between some members and not others can provide additional information pertinent to such subjective consideration. As such, it is noted, these social networks 112 represent a potentially rich source of data concerning the subjective mindset of their members. Predictive pairing server 108 accesses such social network data and, using various rules, executes a psychometric pairing engine, algorithm, application, etc. to identify potential clients from the provider's social network (provider network 115) who, subjectively, might be a good “fit” for provider 101.

By way of contrast, FIG. 1 also illustrates professional service provider 101 conducting a traditional marketing effort 138 (as signified by the billboard). Of course, the provider 101 during such efforts might employ many different types of traditional marketing techniques characterized in part by advertising in newspapers, magazines, radio, television, personal websites, agency websites, etc. as well as the billboard. These efforts represent an effort to inform various members of population 140 of the provider's availability and perhaps the provider's qualifications, experience, success, etc. In addition, or in the alternative, professional service provider 101 might attempt to form fortuitous relationships 142 through their personal contacts 144, relationships, etc. during their day-to-day so-called “real-life” activities. As disclosed elsewhere herein, such efforts are often time-consuming, expensive, laborious, etc. yet provide no, or little basis on which the client and professional service provider 101 can build the sort of trust that often precedes a permanent relationship.

System 100 allows professional service providers 101 alternative (and often (and often more efficient, targeted, etc.) ways to identify potential clients and can allow them to predict their likelihood of finding a successful fit or pairing 106. Moreover, system 100 allows clients and or providers 101 opportunities to build upon their trust in one another founded in their prior associations (or borrowed via their mutual contacts) FIG. 1 also illustrates that one type of professional service provider 101 that can use systems such as system 100 to identify potential clients is real estate agents 102. In which case their computing device might be deemed an agent computing device 106. Likewise, their personal social network 114 might be deemed an agent network 116.

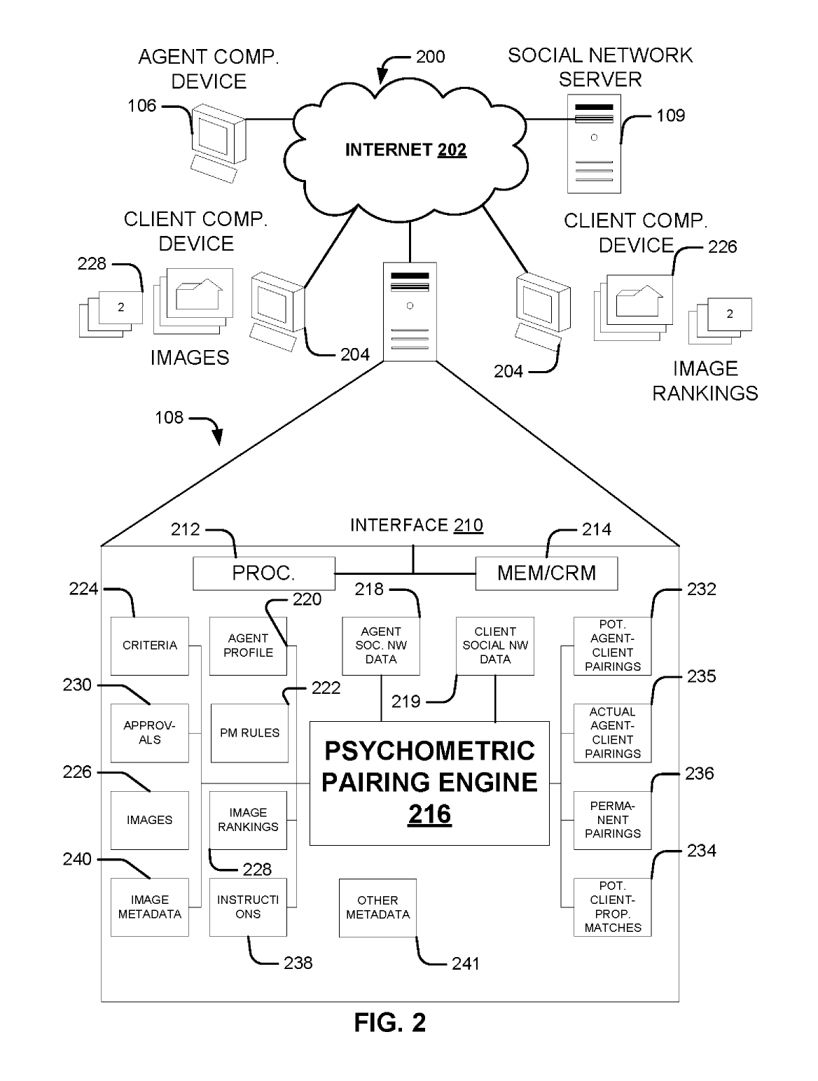

FIG. 2 illustrates a system for predictively pairing real estate agents and real estate clients. While FIG. 2 illustrates real estate agents and clients, those skilled in the art will understand that system 200 can be used to pair professional service providers 101 of many types with clients. More specifically, FIG. 2 illustrates a system 200 which includes network 202, client computing devices 204, interface 210, processor 212, memory 214, psychometric pairing engine 216, agent social network data 218, social network data 219; agent profile 220, psychometric engine rules 222, property criteria 224, property images 226, image rankings 228, client approvals 230, potential pairings 232, potential matches 234, actual pairings 235, permanent pairings 236, and instructions 238. While, FIG. 2 illustrates a system for pairing real estate agents with potential clients, it will be understood that the system 200 of FIG. 2 could be used by other professional service providers 101 to find clients. In some embodiments, the network 202 is the Internet. However, network 202 could be any wide area network (WAN), local area network (LAN), cellular telephony system, etc. capable of allowing communications between the various computing devices (for instance agent computing device 106, predictive pairing server 108, social network servers 109, client computing devices 204, etc.) connected thereto. The client computing devices 204, like many other computing devices in system 200 can be any type of computing device. Moreover, they need not be “client” devices in the sense of client-server “client” devices although they can be. Instead, or in addition, client computing devices 204 of the current embodiment are computing devices through which clients and potential clients of agent 102, members of various social networks 112, and other users can access the system 200 or at least some of its component parts.

With ongoing reference to FIG. 2, the drawing also illustrates predictive pairing server 108 in more detail. More specifically, FIG. 2 shows that the predictive pairing server 108 of the current embodiment includes interface 210, process 212, and memory (or computer readable media) 214 which are in communication with one another. Interface 210 is configured to allow the predictive pairing server 108 (and/or its internal and/or peripheral components) to communicate with the network 202 and/or other computing/communication devices connected thereto. Note that while processor 212 is illustrated as being a processor, it can be any type of device currently available or that might be developed capable of performing the methods disclosed herein.

Memory 214 is in communication with the processor 212 and stores a number of items. For instance, it stores processor executable instructions which when executed by the processor 212 cause the processor 212 to perform various methods such as those disclosed herein. Instructions 238 include code, routines, algorithms, etc. which together constitute the psychometric pairing engine 216 and/or its functionality. Indeed, instructions 238 can include various rules 222 for the psychometric pairing engine 216 which instruct it (in whole or in part) how to perform the various psychometric pairings and matchings disclosed herein. These rules 222 can be created, stored, modified, deleted, etc. by agents 102 and/or administrative users via interface 210 as might be desired. Furthermore, the psychometric pairing engine 216 can be based on any available (or yet to be developed) psychometric application, program, etc. Indeed, in some embodiments, the psychometric pairing engine 216 is modified to consider the various inputs which system 200 directs to it or which the rules 222 cause it to seek (and/or consider) in the social networks 112.

FIG. 2 also illustrates that the predictive pairing server 108 includes social network data regarding various agents 102 (or agent social network data 218). This data includes, but is not limited to, their connections in their agent network 116, their likes, dislikes, associations, activities, and any other information available via the social networks 112. The predictive pairing server 108 can also be configured to query agent 102 regarding various other types if information which might be pertinent to the psychometric pairing engine 216 as configured by the rules 222. For instance, the predictive paring server 216 could query agent 102 regarding the types of clients they seek with regard to various types of property, the personality types they prefer to work with (as measured by non-limiting tests such as the Meyers-Briggs™ personality test), their incomes, current and past residences, etc. From the agent social network data 218, their answers to such queries, and other information, the predictive pairing server 216 of the current embodiment builds the agent profiles 220 for the various agents 102. Moreover, the predictive pairing server 216 could be configured to query the user whether the user was a client seeking a professional service provider 101, a provider 101 seeking clients, and/or what type of professional service and/or provider might be involved in the search. Predictive pairing server 216 could be further configured to query the user regarding criteria that might be peculiar to the type of service/provider involved or sought.

The criteria 224 illustrated in FIG. 2 include summary information regarding various properties that might be of interested to a real estate client or that might assist one in choosing such properties. For instance, criteria 224 could include the type of property that a particular listing (MLS—Multiple Listing Service or otherwise) describes. In one scenario, a particular property could be a residential house built according to the “ranch” style. Many other styles exist and include cape cod, split-level, modern, Victorian, etc. But properties are not limited to residential properties. Thus, while a particular criteria 224 might indicate a single-family residential property, criteria 224 might also indicate a multi-family residential property, a duplex, a quadraplex, an apartment or apartment building, and so forth and so on. The particular criteria 224 in this scenario could also extend to commercial, office, light industrial, etc. properties. Nonetheless, other criteria 224 could indicate square footage, whether or not the property is air conditioned, how many bathrooms and/or bedrooms it has, etc. Furthermore, predictive pairing server 108 could be configured to use various criteria 224 input by clients, agents 102, administrative users, etc. to aid in the psychometric pairing of agent 102 and various potential clients in the social networks 112. Moreover, such criteria can be related to other types of professional service providers if they are involved in a particular search. For instance, for lawyers, criteria 224 could include their legal specialties, the jurisdictions in which they are licensed, their experience level, etc. For painters (or artists), criteria 224 could include the types/styles of paintings that they prefer, famous artists who influenced them, subject matter that they prefer, etc. In some embodiments, psychometric pairing engine 216 considers such data when performing psychometric pairings and matchings.

In some embodiments, predictive pairing server 108 could also store images (still, moving, or otherwise) of various properties. These images 226 could be stored in various formats (JPEG, MPEG, PDF, GIF, PNG, etc.) and could include images captured of the exteriors and/or interiors of various properties. More specifically, for some or all property listings accessible by the predictive pairing server 108, images 226 could include images of one or more rooms of the respective properties. Further, the images 226 can be of available property, property that is currently off the market, property representative of certain styles of real property, etc. The predictive pairing server 108 of the current embodiment also includes (or gathers and/or stores) metadata associated with each image 226. Such image metadata 240 could include a reference to the corresponding property and/or listing, which room (or type of room) it captures, and one or more user rankings 228, qualitative descriptions, keyword taggings, etc. associated with the image. For service providers of other types, images 226 could capture corresponding subject matter. Thus, images 226 for an artist might include images 226 of their works while for travel agents images 226 might include images of their previous clients, locales that they prefer, etc. If desired, psychometric engine 216 could consider such information when performing psychometric pairings and matchings.

Furthermore, predictive pairing server 108 could be configured to distribute the images 226 to various users and query these users for their rankings of each of the images 226. Predictive pairing server 108 of the current embodiment associates the responding users with their respective image rankings 228 (and correlates those image rankings 228 to the images 226). Thus, the psychometric pairing engine 216 can use these correlations (according to various rules 222) in determining whether one user's subjective tastes in rooms, properties, etc. might indicate that their contacts in their personal networks 114 would also like those rooms, properties, etc. Thus, the psychometric pairing engine 216 could use these image rankings 228 (and associated metadata) as inputs to psychometric matching algorithms which output suggestions to agent 102 (the clients, potential clients, or other users) that one or more clients (or potential clients) might find a particular property(s) attractive in accordance with their subjective tastes.

With further reference to FIG. 2, the psychometric pairing engine 216 can operate as follows. More specifically, psychometric pairing engine 216 can read the rules 222 and determine what actions various users might desire for it to perform. In some cases, the rules 222 might indicate that the psychometric pairing engine 216 is to perform a psychometric pairing to determine which members of a particular agent network 116 (whether close, secondary, tertiary, or distant) might be a good fit for the corresponding agent 102. In such cases, the rules might indicate that the psychometric pairing engine 216 consider the corresponding agent profile 220, certain pertinent criteria 224, various image rankings 228, etc. The psychometric pairing engine 216 of the current embodiment would then compare the various members of the agent network 116 (or rather the social network data pertaining to the various users) to the agent profile 220 to determine which users would likely pair successfully with agent 102. Of course, if desired, system 200 could be configured such that a user or prospective client could imitate predictive pairing. In which case, the predictive pairing engine 216 could examine that user's personal network 214 (and other connected social networks 214) to identify and predictively pair agents 102 (or other professional service providers 101) with that user.

As indicated, the psychometric pairing engine 216 might generate a likelihood of a successful pairing rather than a binary, yes/no, on/off, etc. indication. Thus, psychometric pairing engine 216 could generate or otherwise produce potential pairings 232 for agent 102 (or other user). These potential pairings 232 could be output to agent computing device 106 or client computing device 204 in the form of suggested agent-client pairings 232 along with a percentage indicating odds of success. Or the psychometric pairing engine 216 could output a list with each potential agent-client pairing along with some rough indication of whether it judged success unlikely, somewhat likely, likely, or highly likely. Of course, other measures of these probabilities could be used without departing from the scope of the disclosure. Thus, in the current embodiment, the psychometric engine outputs potential pairings 232 whether initiated by agent 102, a potential client, or otherwise.

In addition, or in the alternative, the psychometric pairing engine 216 could produce potential matches between various clients (or potential clients) and various real properties. For instance, the psychometric pairing engine 216 operating according to certain rules 222 could examine the image rankings 228 of a particular client and compare them to the image rankings 228 input by members of that client's personal network 114. Using psychometric analysis techniques, the psychometric pairing engine 216 could determine which images 226 the client might subjectively find attractive from their connections which share certain psychometric characteristics as revealed by the social network data 219 corresponding to those parties. If indicated by the pertinent rules 222 (and/or if indicated by a user request), the psychometric pairing engine 216 could output a list of the properties corresponding to images 226 of various (available) properties. Thus, the psychometric pairing engine 216 could output a list of potential matches 234 in the various listings accessible to it (or the predictive pairing server 108). Moreover, as noted elsewhere herein, system 200 can be configured to operate in the context of professional service providers 101 other than real estate agents 102. For instance, if system 200 operates in the context of artists as professional service providers 101, the images could be of that artist's prior work, other artist's work, the work of so-called “masters” (Rembrandt, Monet, Picasso, etc.) with the predictive pairing engine being configured to psychometrically match the client and various pieces of art.

FIG. 2 also illustrates that predictive pairing server 108 of the current embodiment could store, receive, etc. various approvals 230 from various users of the system 200. For instance, in some cases, agent 102 will receive there from a list of potential pairings 232. Agent 102 might peruse that list and determine (from the social network data 219 and/or other data available via the system 200) which of the potential pairings 232 appeal to them. Agent 102 could initiate contact with the corresponding users asking if they wanted to become a client. In some embodiments, the agent 102 might pay a fee to system 200 to engage that contact through the system 200. Additionally, or in the alternative, if chosen or referred by another client, agent 102 could in some instances be placed as a “sponsored” agent. In other scenarios, agent 102 could pay a fee and be listed as a paid or “sponsoring” agent.

It might be worth noting that one of the factors that could be used in psychometrically pairing agent 102 with potential clients is the proximity of agent 102 (or professional service provider 101) and a particular potential client(s) in the applicable personal network(s) 114. Accordingly, it could be the case that the potential client will answer affirmatively in accordance with that proximity. More specifically, since agent 102 and the potential client have compared favorably during their psychometric pairing (which produced their potential pairing 232), it would seem that agent 102 stands a relatively good chance of obtaining their approval 230. Indeed, in at least some cases, the potential client will send that potential client's approval 230. If so, the predictive pairing server 108 would change that potential pairing 232 into an actual pairing 235 indicating that both parties desire (and have entered into or likely will enter into) an agent-client relationship.

At some point, predictive pairing server 108 or agent 102 could ask the client whether they wish to make that relationship more or less permanent. If the client so desires, the system 200 could be configured to allow them to return a corresponding approval 230. The system 200 could be configured, as desired, to allow clients to opt in or opt out of such arrangements. Upon receiving that approval 230, predictive pairing server 108 could change the corresponding actual pairing 235 into a permanent pairing 236. Furthermore, in systems 200 of the current embodiment, the predictive pairing server 108 outputs an indication that both parties have consented to making their pairing permanent. Responsive thereto, various social networks 112 could update the social network data 219 (in their respective social network servers 112) indicating that the particular client has selected the particular agent 102 as their permanent real estate agent (or other professional service provider 101 as the case might be). Making such information available over social networks 112 (or otherwise) can be deemed “persisting” such permanent relationships. Of course, system 200 could be configured to act in a similar fashion for professional service providers 101 other than real estate agents 102 without departing from the scope of the disclosure. At this juncture it might be helpful to consider some methods related to psychometrically pairing real estate agents 102 (and/or other professional service providers 101) with potential clients and/or related to psychometrically matching various clients and/or potential clients with various pieces of real property with which an agent 102 might help them (or other professionally provided services).

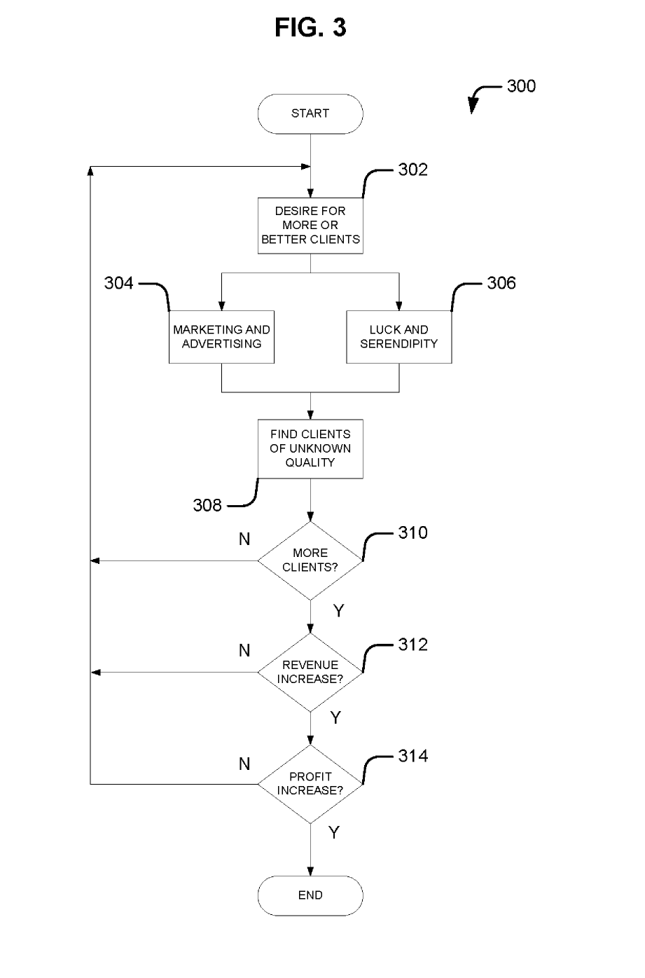

FIG. 3 illustrates a flowchart of a method for identifying potential real estate clients. As FIG. 3 shows, method 300 of the current embodiment begins with agent 102 (or some other professional service provider 101) recognizing a desire to identify more, better, different, etc. clients. See reference 302. Agent 102 might therefore begin (or modify) some marketing/advertising campaign as shown at reference 304. In some cases that campaign might include networking and or other activities which might garner agent 102 additional personal contacts from which to identify and/or draw potential clients. Of course, agent 102 could depend on (or take advantage of) lucky, fortuitous, serendipitous, etc. events to bring such persons into their vicinity and/or group of personal contacts. See reference 306. In either case, it is unlikely that agent 102 will be able to ascertain or predict their likely success with these fortuitously located potential clients. See reference 308.

As a result, agent 102 is likely to have to evaluate (over time) their success or (more likely) lack thereof with these new clients. For instance, agent 102 might desire to determine whether their client base has grown or not. See reference 310. If not, agent 102 might repeat some or all of the foregoing portions of method 300. If so, agent 102 might do so any way or continue with method 300 at reference 312. Note that at this point, agent 102 might have already incurred significant expenses or spent significant time in trying to find these new clients. Yet, agent 102 (operating consistent with heretofore available approaches) might still have no way to predict their chances of success with these new clients. This of course contrasts with embodiments disclosed herein.

As indicated at reference 312, another indication of whether agent 102 was successful might be whether their overall, top-line revenues increased as a result of their previous marketing efforts (see reference 302, 304, 306, and/or 308). Of course, since time might be progressing and other activities might be occurring, it might be difficult for agent 102 to ascertain their success with regard to such activities. Indeed, events might obscure the results thereof. Nonetheless, agent 102 could (in the absence of increased revenues) return to reference 302 and repeat all or portions of method 300. Again, agent 102 might be investing heavily in this approach with little success and/or little hope of predicting their success. Nonetheless, agent 102 could continue with method 300.

As indicated at reference 314 of FIG. 3, another indication of whether the marketing activities of agent 102 have met with some success would be an increase in profits. An increase in profits might indicate that agent 102 has found better clients and is spending less time marketing and more time making deals (or if some other type of professional service provider 101 is involved, providing their services). Or it could indicate that agent 102 is making better deals for his clients and/or that clients are returning with repeat business. And if so, agent 102 could maintain their marketing efforts as-is. In which case, agent 102 might exit from method 300 although they need not. In fact some agents 102 might continue method 300 indefinitely. Of course, some agents 102 might find themselves endlessly repeating method 300 in a vain effort to improve or otherwise change their client base. See reference 314.

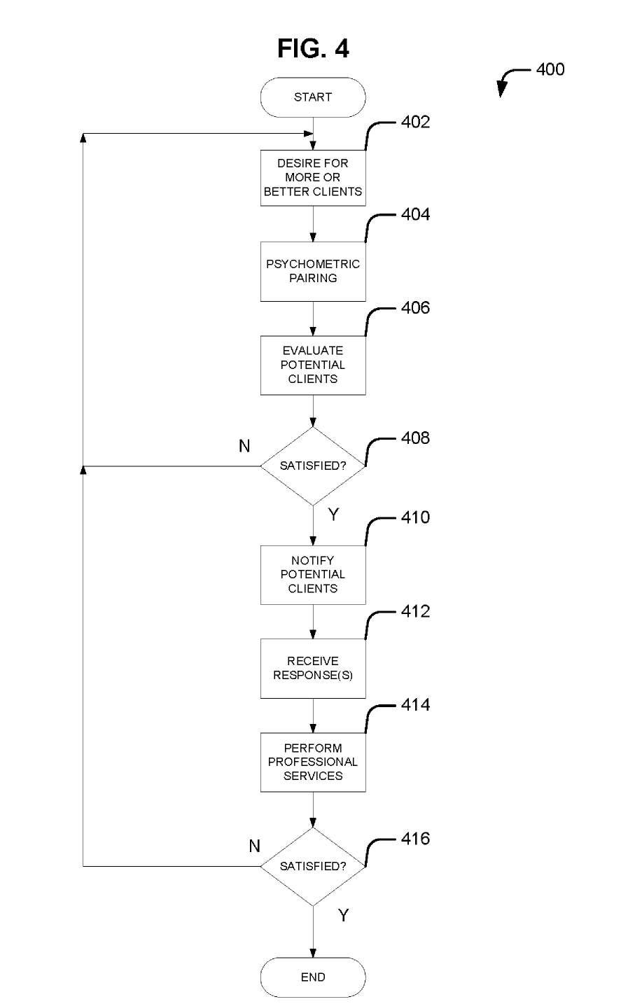

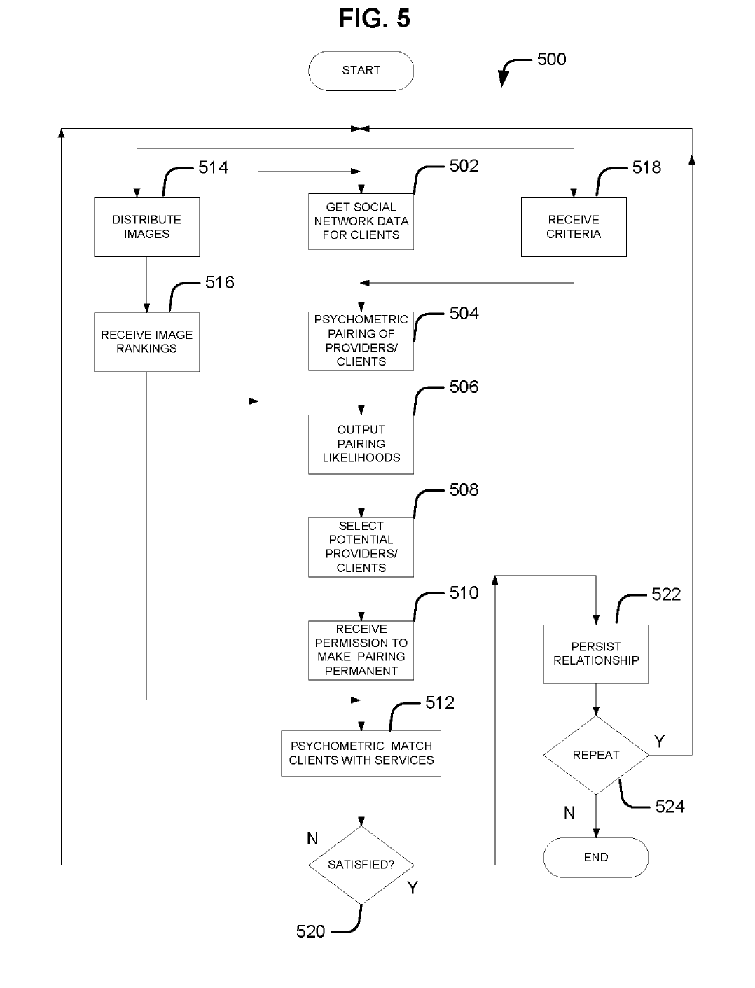

However, agents 102 and/or other professional service providers 101 need not do so. Instead, or in addition, by employing systems, apparatus, methods, etc. disclosed herein, agents 102 can improve or otherwise change their client base and/or their chances of success accordingly. For instance, agents 102 could initiate method 400 and/or method 500 (see FIGS. 4 and 5 respectively). By doing so, not only can agents 102 increase their likelihood of success, but they can track and measure their results. This situation is so, because as psychometric pairing engine 216 outputs potential pairings 232, predictive pairing server 108 can be configured to track whether the corresponding potential clients approve the parings, become clients, buy/sell property through agent 102, approve becoming permanent client, revenues realized by agent 102, profits realized by agent 102, etc.

Accordingly, FIG. 4 illustrates a flowchart of a method for identifying potential professional services clients. In the current embodiment, method 400 can begin with agent 102 and/or another professional service provider 101 recognizing a desire for identifying new clients as indicated at reference 402. FIG. 4 also illustrates that, at reference 404, agent 102 requests that predictive pairing server 108 perform a psychometric pairing for himself with various members of his agent network 116. Agent 102 might, if desired, enter certain criteria 224 against which predictive paring server 108 is to run the psychometric pairing and might enter, alter, delete, etc. one or more rules 222. Thus, predictive pairing server 108 can perform a psychometric matching between the corresponding agent profile 220 and social network data 218 for various social network members in agent social network 116. If desired, in the alternative or in addition, a client, potential client, or other user could recognize a desire to find a professional services provider 101 of some type. In which case, method 400 could operate to psychometrically pair that user with a professional service provider 101 of a selected type. Moreover, such users could access predictive pairing server 108 via client computing devices 204 and/or network 202 if desired.

With continuing reference to FIG. 5, agent 102 receives a set of potential pairings 232 from predictive pairing server 108. See reference 404. Agent 102 can evaluate those potential pairings 232 (or rather the corresponding potential clients) as indicated by reference 406. In doing so, agent 102 can access the social network data 219 underlying the potential pairings 232 as well as any associated criteria 224 via system 200. Thus, agent 102 can evaluate the potential clients identified by predictive pairing server 108 and more specifically psychometric pairing engine 216. Of course, if a client, potential client, or other user initiated method 400, that user could evaluate the various professional service providers 101 identified by psychometric pairing engine 216. See reference 406.

With ongoing reference to FIG. 4, method 400 can continue with agent 102 deciding whether or not they are satisfied with the potential clients. If not, agent 102 can (alter some or all of their inputs if desired and) re-run some or all of the psychometric pairing as indicated by method 400 returning to operations 402, 404, and 406. See reference 408. If agent 102 is satisfied with the potential clients identified by psychometric pairing engine 216, method 400 can continue to reference 410.

Accordingly, agent 102 can notify one or more of the identified potential clients via system 200 if desired. See reference 410. Moreover, agent 102 can await and/or receive responses from the various potential clients as indicated at reference 412. If a client approves the potential pairing, predictive pairing server 108 can change the potential pairing into an actual pairing. See reference 412. Agent 102 can begin performing real estate related services for their new client as reference 414 shows. Moreover, agent 102 can receive feedback from this particular client (as well as others) and determine whether the new relationship is developing as desired. If not, agent 102 can take corrective steps and/or perform method 400 (in whole or in part) to identify further potential clients. See reference 416. If agent 102 is satisfied, they can exit method 400 or even perform method 400 again depending on their desires. Thus, FIG. 4 illustrates a method for agents, professional services providers 101, and/or others to identify and/or retain new clients or professional service providers 101 as the situation might suggest.

FIG. 5 illustrates a flowchart of another method for identifying potential professional services clients. More specifically, FIG. 5 illustrates method 500 which, in the current embodiment, includes predictive pairing server 108 obtaining social network data 219 pertaining to various members of one or more agent networks 116 (and/or the social networks 114 of a professional services provider 101). Such social network data 219 gathering can be done periodically, on-demand, when potential matchings are requested or at other times. See reference 502. Note that, in part or in whole, because various potential clients to be identified in method 500 might share mutual connections with the agent 100 (as evidenced by their respective personal networks 114) a basis for trust might exist between these parties. In some cases, furthermore, these parties might have known each other or dealt with one another at some other time. Again, such prior associations can provide a basis for trust otherwise lacking in many fortuitous relationships 142 (see FIG. 1). Moreover, it might be the case that a client, potential client, or other user might initiate method 500 to identify professional service providers 101 with whom they might be interested in forming a relationship. In which case, reference 502 would indicate that predictive paring server 108 could gather social network data 219 regarding various connections of the user in their personal network(s) 114.

As noted elsewhere herein, at some time, predictive pairing server 108 can distribute images 226 of various properties to such members via system 200. These images can include exterior and interior images of various properties. Moreover, metadata 240 associated with each image 226 can identify which property, room, etc. the image has captured. Predictive pairing server 108 can also request that the recipients of the images 226 rank them and return such rankings to the predictive pairing server 108. While the particular form of the ranking is non-limiting, some rankings could be returned in yes/no, thumbs up/down, 1-10 scale, etc. formats. Of course, for embodiments involving professional services providers 101 other than real estate agents 102, the images 226 could correspond to the services provided thereby. For instance, if the professional services provider 101 is reconstructive surgeon, images 226 could be before/after images of their (consenting) patients. See reference 514.

When such image rankings 228 return to predictive pairing server 108 they can be accompanied by metadata indicating the social network members who provided the rankings. See reference 516. As is disclosed elsewhere herein, these image rankings 228 can be used in various manners by predictive pairing server 108 during method 500, portions thereof, and/or under other circumstances.

In the meantime, various users of system 200 can be entering criteria associated with one or more properties for which the agent's 102 services might be sought. Agents and social network members can also enter criteria 224 for property which they wish to find, which they own, etc. Moreover, such criteria 224 can be sent to predictive pairing server 108 along with metadata indicating its originator, property it is associated with etc. Furthermore, these criteria could correspond to services associated with other types of professional services providers 101. For instance, suppose that instead of a real estate agent 102, an accountant is the professional service provider 101 involved with method 500. In such an instance, criteria 224 could relate to whether or not they have a CPA (Certified Public Accountant) license, the size (as measured by revenues) of clients served, the type(s) of industries they serve, etc. See reference 518. Note that criteria 224 can come into play at other references in method 500 as is disclosed elsewhere herein.

Method 500 can continue with psychometric pairing engine 216 performing psychometric pairings between agent profiles 218 and the various members of these agents' agent networks 116 (or social network data 219 pertaining thereto). More specifically, psychometric pairing engine 216 can perform according to rules 222 and, using the social network data 219, determine which social network members might be likely fits for agents 102. Psychometric pairing engine 216 can also determine the likelihood that such pairings might result in success for agents 102. As noted elsewhere herein, it might be the case that a client, potential client. or other user is trying to identify professional services providers 101 with whom they might wish to form a relationship (or at least perhaps use their services). In which case, psychometric pairing engine 216 could determine which social network members might be likely fits (as providers) for that user. Note that psychometric pairing engines 216 of embodiments can incorporate various algorithms, modules, code, etc. available from Apache Software Foundation under their Apache TLP Mahout project and which affect the psychometric pairings, matchings, etc. disclosed herein. See reference 504. Predictive matching engine 216 can be based on a platform or platforms designed for psychographic matching and collaborative filtering. Moreover, it can use some combination of psychographic filtering algorithms, collaborative filtering algorithms, pattern matching formulas, predictive matching formulas, etc. including but not limited to slope one algorithms, distributed item-based collaborative filtering, collaborative filtering using a parallel matrix factorization and/or others. In addition, or in the alternative, other technologies may be employed in part or whole including but not limited to SQL-MapReduce®, Canopy®, neural networks, fuzzy k-means and others. Accordingly, psychometric pairing engine 216 can output the potential pairings 232 to the corresponding agents 102 (or other user) as indicated at reference 506.

With continuing reference to FIG. 5, method 500 can continue with predictive pairing server 108 receiving potential client selections from various agents 102 (or other professional services provider 101). In some embodiments, predictive pairing server 108 sends the selected potential clients notifications that the corresponding agents wish to approach them regarding representing them in real estate related matters (or vice versa). See reference 508. Furthermore, at some point, one or more of the clients might indicate to the predictive pairing server 108 that they wish to make their relationships with their agents permanent. Responsive thereto, predictive pairing server 108 changes the relationships between these clients and their agents to that of permanent relationships. Predictive pairing server 108 can also send to the social networks 112 an update to the status of the permanent clients indicating that they have now selected their agents as their permanent agents. As a result, the various social networks 112 can indicate that the agents now represent the clients on a permanent basis. See reference 510 of FIG. 5. Indications of the permanent relationship can remain visible in the social networks 212 (of which the now permanent client is a member) until the client alters that status. Moreover, in some embodiments, such a choice can indicate that a client has agreed to use the services of agent 102 exclusively. That exclusivity and/or the permanency of the agent-client relationship can be determined, set, etc. by the client. Thus, when other members view the social network 112 pages associated with these clients, they could see a persistent indication of that status.

At some point, agent 102 or a client or both might request that a client be psychometrically matched to one or more properties. See reference 512. Psychometric pairing engine 216 can access social network data 219, criteria 224, and image rankings 228, and associated metadata regarding this information and, using such information, psychometrically match the client(s) to various properties. See reference 512. Note that, in some embodiments, the person requesting a psychometric match between themselves and various properties need not be a client, agent 102, or professional service provider 101, nor need they be members of a social network 112. Rather, users can access system 200 via client computing device 204 and request such a psychometric matching. Some embodiments, moreover, provide stand alone systems, apparatus, and methods for distributing images 226, receiving image rankings 228, and providing psychometric matches between various users and various properties (and/or professional services provided by various professional services providers 101).

These properties, or rather their corresponding listings, can be forwarded to the appropriate client. The client can evaluate the properties and return indications to predictive pairing server 108 of their satisfaction/curiosity regarding the properties. If the client is not interested in the properties (or some number or percentage of them), predictive pairing server 108 can repeat some or all of method 500 as illustrated by reference 520 of FIG. 5. However, if the client indicates sufficient satisfaction, method 500 can continue.

It might be worth noting that psychometric “matching” is used herein in the sense of identifying properties and/or services that a user might subjectively desire to obtain (or have performed) for themselves or on their behalf. Psychometric “pairing,” on the other hand, is used herein in the sense of identifying professional service providers 101 which users might subjectively desire to work with (and/or vice versa). Thus, psychometric pairing accounts for not only the subjective nuances and vagaries involved in identifying goods/services associated with subjective considerations but also with nuances and vagaries associated with working, but nonetheless personal (and therefore subjective) relationship “fits.”

Still with reference to FIG. 5, method 500 can include a client indicating that they wish to make their relationship with their agent permanent. As a result, predictive pairing server 108 can output an indication to the social networks 112 (which that client belongs to) that that the client has elected to make the relationship permanent. The social networks 112 can be configured to indicate that status. Thus, third parties who might view the social network page(s) associated with the client will see that the client is a permanent client of their agent. In this way (and/or perhaps others) system 200 of embodiments can be said to persist these sorts of permanent relationships. Such implicit endorsements, it is noted, might aid agent 102 in their marketing efforts. Moreover, because a basis for trust between these parties might pre-date their pairing, it is more likely than it otherwise would be that these parties will form a permanent relationship. See reference 522. If desired, method 500 can be repeated in whole or in part as indicated at reference 524 or it can be terminated if desired.

Accordingly, embodiments provide systems, apparatus and methods that enable real estate agents (and/or other professional service providers) to locate, establish, maintain, improve, etc. client relationships based on the psychometric pairing of agents with clients. Psychometric engines of embodiments provide psychometrically-based agent-client pairings which will often increase an agent's subjective likelihood of success in identifying potential clients and/or retaining the same. These pairings can create a higher probability that the agent and their clients will work together and subjectively succeed in satisfying their transactional goals. Features provided by various embodiments provide clients, potential clients, and others, psychometrically matched real estate suggestions and can make real estate searches easier and subjectively more successful for both clients and agents. Moreover, systems of embodiments offer suggested pairings between the clients and agents and offer methods to track and manage which agent-client relationships are exclusive while providing agents and clients with suggestions regarding which properties to investigate further and/or visit. Embodiments, therefore free up time for agents to provide better/more thorough services, increase the client bases, etc. Furthermore, embodiments enable agents and clients to subjectively improve their real estate transaction experiences by reducing or eliminating time used in searching for the right agent/client and more suitable properties through, in part or whole, leveraging systems, apparatus, methods, etc. provided by various embodiments.

### CONCLUSION

Although the subject matter has been disclosed in language specific to structural features and/or methodological acts, it is to be understood that the subject matter defined in the appended claims is not necessarily limited to the specific features or acts disclosed above. Rather, the specific features and acts described herein are disclosed as illustrative implementations of the claims.

1. A method for predictively pairing real estate agents and potential real estate clients, the method comprising:
retrieving social network data for each of a plurality of social network members from a social network using a processor;
comparing the social network data for each of the social network members to a profile of a real estate agent to psychometrically pair the social network members as potential real estate clients for the real estate agent using the social network data and the processor, wherein the social network data for one of the potential real estate clients further comprises social network data for a connection of the potential real estate client in the social network to another of the social network members;
outputting an indication of at least one psychometric pairing of a potential real estate client with the real estate agent profile via an interface in communication with the processor; and
distributing images of real property to the social network members and accepting rankings of the real property images from the social network members via the interface.

2. A method comprising:
receiving social network data for each of a plurality of social network members from a social network using a processor;
comparing the social network data for each of the social network members to a profile of a real estate agent to psychometrically pair the social network members as potential real estate clients for the real estate agent using the social network data and the processor; and
outputting an indication of at least one psychometric pairing of a potential real estate client with the real estate agent profile via an interface in communication with the processor.

3. The method of claim 2 further comprising distributing images of real property to users and accepting rankings of the real property images from the users via the interface.

4. The method of claim 3 further comprising using the real property image rankings in a psychometric matching of the potential real estate clients with real estate.

5. The method of claim 4 wherein the psychometric matching of the potential real estate clients with real estate and the psychometric pairings of the potential real estate clients and the real estate agent profile further comprise using real estate criteria received via the interface and the real property image rankings.

6. The method of claim 2 further comprising using the social network data in a psychometric matching of potential real estate clients with real estate properties.

7. The method of claim 2 wherein the social network data for one of the potential real estate clients further comprises social network data for a connection of the potential real estate client in the social network.

8. The method of claim 2 wherein the outputting of the indication of psychometric paring further comprises outputting likelihoods of the psychometric pairings.

9. The method of claim 8 wherein there is only one likelihood of a psychometric pairing and wherein the likelihood of a psychometric pairing is high.

10. The method of claim 2 wherein the psychometric pairing of potential real estate clients and the real estate agent profile further comprises using real estate criteria received from the potential real estate client via the interface.

11. An apparatus comprising:
an interface;
a memory; and
a processor in communication with the interface and the memory, the memory storing processor executable instructions which when executed by the processor cause the processor to perform a method further comprising,
accessing social network data for each of a plurality of social network members from a social network;
comparing the social network data for each of the social network members to a profile of a real estate agent to psychometrically pair the social network members as potential real estate clients for the real estate agent using the social network data; and
outputting an indication of the matches of the potential clients with the real estate agent profile via the interface

12. The apparatus of claim 11 wherein the method further comprises distributing images of real property to the social network members and accepting rankings of the real property images from the social network members via the interface.

13. The apparatus of claim 12 wherein the method further comprises using the real property image rankings in a psychometric matching of the potential real estate clients with real estate properties.

14. The apparatus of claim 12 wherein the method further comprises using real estate criteria received via the interface and real property image rankings in the psychometric matching of the potential real estate clients with real estate and in the psychometric pairing of the potential real estate clients and the real estate agent profile.

15. The apparatus of claim 11 wherein the method further comprises using the social network data in a psychometric matching of potential real estate clients with real estate.

16. The apparatus of claim 11 wherein the social network data for one of the potential real estate clients further comprises social network data for a connection of the potential real estate client with another social network member in the social network.

17. The apparatus of claim 11 wherein the outputting of the indication of psychometric pairings further comprises outputting likelihoods of the psychometric pairing.

18. The apparatus of claim 11 wherein there is only one likelihood of a psychometric pairing and wherein the likelihood of the likelihood of the psychometric pairing is high.

19. The apparatus of claim 11 wherein the psychometric pairing of potential real estate clients and the real estate agent profile further comprises using the real estate criteria received from the potential real estate client via the interface.

20. The apparatus of claim 11 wherein the method further comprises making the psychometric pairing of the potential real estate clients and the real estate agent persistent in the social network.
